(19) United States
(12) Patent Application Publication
(10) Pub. No.: US 2026/0129010 A1
(43) Pub. Date: May 7, 2026

(54) MULTI-MODAL CHATTING APPARATUS AND METHOD

(71) Applicant: ELECTRONICS AND TELECOMMUNICATIONS RESEARCH INSTITUTE, Daejeon (KR)

(72) Inventors: Ki Young Lee, Daejeon (KR); Oh Woog Kwon, Daejeon (KR); Jihee Ryu, Daejeon (KR); Young-Ae Seo, Daejeon (KR); Jin SEONG, Daejeon (KR); Jong Hun Shin, Daejeon (KR); Yo Han Lee, Daejeon (KR); Soojong Lim, Daejeon (KR); Jeong Heo, Daejeon (KR)

(21) Appl. No.: 19/077,224

(22) Filed: Mar. 12, 2025

(30) Foreign Application Priority Data
Nov. 5, 2024 (KR) 10-2024-0155301

(51) Int. Cl. H04L 51/04; G06T 11/00; G06V 10/74; H04L 51/02

(52) U.S. Cl. CPC H04L 51/04; G06T 11/00; G06V 10/761; H04L 51/02

(57) ABSTRACT

Provided are a multi-modal chatting apparatus and method which automatically generate and present a picture related to a conversation, if necessary, in a situation in which a user and a system have a conversation based on text or a voice. The multi-modal chatting apparatus includes a text response generation unit configured to generate a text system response that needs to be now spoken based on conversation context between a system and a user, a picture expression generation unit configured to generate picture expression text that expresses contents to be expressed by a picture based on the generated text system response, and a picture generation unit configured to generate a picture based on the generated picture expression text.

### CROSS-REFERENCE TO RELATED APPLICATION(S)

This application claims priority from and the benefit of Korean Patent Application No. 10-2024-0155301, filed on Nov. 5, 2024, which is hereby incorporated by reference for all purposes as if set forth herein.

### BACKGROUND

### 1. Technical Field

The present disclosure relates to a multi-modal chatting apparatus and method.

### 2. Description of Related Art

A text or voice-oriented conversation is one of the most basic methods of communication for humans. However, when a purpose is to convey more complicated concepts or situations, rather than just simple meanings, using only text or voice does not aid efficient and fast understanding between the individuals involved. Such a phenomenon actually occurs in various contexts. In an educational conversation between a student and a teacher, the teacher draws and explains a picture on a chalkboard or a scratch pad in order to help the student understand more easily. In this case, the picture is a more efficient tool than text in helping the student grasp a problem.

Furthermore, this is especially noticeable in conversations with the elderly or socially disadvantaged individuals. For example, when explaining the functions of an air conditioner or a TV remote controller to elderly parents who do not live their children, it is difficult to explain the functions of the remote controller buttons in detail and efficiently using only text or voice so that the elderly parents can easily understand the functions of the remote controller buttons. Moreover, even in a conversation processing field that is rapidly developed recently, in conversations between the socially disadvantaged including old men and a system, there are many cases in which it is difficult to make a user understand a specific concept or fact in conversations through only text or a voice.

The development of a deep learning-based AI technology has brought significant advancements in various technologies of a natural language processing field. The conversation processing field is not exceptional, and has made a clear progress even in an object-oriented conversation in addition to simple chatting with a system. For such a reason, there have been many attempts to apply a conversation processing model to various fields. For example, examples of such attempts include a care service for the socially disadvantaged including the elderly, tutoring services for language or mathematical problems, a medical service, and a commodity sales service.

However, a conversation simply using only text or a voice has a difficulty in maintaining an efficient conversation between a system and a user. For example, in the case of a conversation with elderly people, to use only text for a specific concept or fact or a method of using a thing has a clear limit. In some cases, desired efficiency may be obtained by explaining oral contents in text along with the sharing of a picture while showing the oral contents in picture.

The same is true in a tutoring domain. In general, when trying to solve mathematical problems, many people actually understand what the problems represent by drawing pictures. For example, a teacher who teaches mathematical problems help students understand by drawing pictures on a blackboard or presenting the pictures on a practice book when the teacher feels that the students lack understanding while explaining the students in a spoken language.

### SUMMARY

Various embodiments are directed to providing a multi-modal chatting apparatus and method which may help the understanding of a user more efficiently by automatically generating and presenting a picture related to a conversation, if necessary, in a situation in which a user and a system have a conversation based on text or a voice.

A multi-modal chatting method according to an embodiment of the present disclosure includes a text system response generation step of generating a text system response that needs to be now spoken based on conversation context between a system and a user, a picture expression generation step of generating picture expression text that expresses contents to be expressed by a picture based on the generated text system response, and a picture generation step of generating a picture based on the generated picture expression text.

In an embodiment, the picture expression generation step includes steps of generating a prompt for generating the picture expression text and generating the picture expression text by inputting the generated prompt to a generative language model.

In an embodiment, the prompt includes a command that determines whether to output the generated text system response without any change or to generate the generated text system response in picture and that enables the picture expression text to be generated when the generated text system response needs to be generated in picture, user information including characteristics of the user, previous conversation context, and the text system response.

In an embodiment, the step of generating the picture expression text by inputting the generated prompt to the generative language model may include outputting, by the generative language model, a signal indicating that a picture is to be not generated when determining to not display system speech contents in picture, and generating, by the generative language model, the picture expression text when determining to construct the system speech contents in picture.

In an embodiment, when it is determined that the system speech contents are to be not displayed in picture in the picture expression generation step, the text system response generated in the text system response step is output. When it is determined that the system speech contents are to be displayed in picture in the picture expression generation step, the text system response generated in the text system response step and the picture generated in the picture generation step are output.

In an embodiment, the picture generation step includes a picture search step of searching for a picture most similar to the picture expression text based on the picture expression text, a picture generation determination step of determining whether to use the retrieved picture or to generate a new picture, and a step of generating and outputting a new picture at least based on the picture expression text by using an AI image generation model when it is determined that the new picture is to be generated and outputting the retrieved picture when it is determined that the retrieved picture is to be used.

In an embodiment, the picture generation determination step includes steps of generating a determination prompt for determining whether to generate a new picture, based on the picture retrieved in the picture search step and picture expression context including user information, the picture expression text, and a conversation history, and determining whether to use the retrieved picture or to generate the new picture based on the generated determination prompt and the retrieved picture.

In an embodiment, in the picture search step, a plurality of pictures most similar to the picture expression text is output. In the step of generating the determination prompt, a plurality of determination prompts is generated by combining the plurality of pictures and the picture expression context. In the picture generation determination step, whether to use a picture having the greatest similarity, among the retrieved pictures, without any change is determined based on similarity between the plurality of pictures and the picture expression context.

In an embodiment, the picture generation determination step includes determining to generate the new picture based on the picture expression text and the retrieved picture when similarity of the retrieved picture is higher than a predetermined threshold value and determining to generate the new picture at least based on the picture expression text when the similarity of the retrieved picture is lower than the predetermined threshold value.

In an embodiment, the multi-modal chatting method further includes a picture reflected text generation step of generating text into which the picture generated in the picture generation step has been reflected by correcting the text system response.

A multi-modal chatting apparatus according to an embodiment of the present disclosure includes a text response generation unit configured to generate a text system response that needs to be now spoken based on conversation context between a system and a user, a picture expression generation unit configured to generate picture expression text that expresses contents to be expressed by a picture based on the generated text system response, and a picture generation unit configured to generate a picture based on the generated picture expression text.

In an embodiment, the picture expression generation unit includes a prompt generation unit configured to generate a prompt for generating the picture expression text and a generative language model configured to generate the picture expression text by receiving the generated prompt.

In an embodiment, the prompt includes a command that determines whether to output the generated text system response without any change or to generate the generated text system response in picture and that enables the picture expression text to be generated when the generated text system response needs to be generated in picture, user information including characteristics of the user, previous conversation context, and the text system response.

In an embodiment, the command of the prompt is an instruction that outputs a signal indicating that a picture is to be not generated when it is determined that system speech contents are to be not displayed in picture and that enables the picture expression text to be generated when it is determined that the system speech contents are to be constructed in picture.

In an embodiment, the multi-modal chatting apparatus outputs the text system response generated by the text response generation unit when the picture expression generation unit determines that the system speech contents are to be not displayed in picture, and outputs the text system response generated by the text response generation unit and the picture generated by the picture generation unit when the picture expression generation unit determines to display the system speech contents in picture.

In an embodiment, the picture generation unit includes an image search unit configured to search for a picture most similar to the picture expression text based on the picture expression text, a picture generation determination unit configured to determine whether to use the retrieved picture or to generate a new picture, and an image generating model configured to generate and output a new picture at least based on the picture expression text when it is determined that the new picture is to be generated and outputting the retrieved picture when it is determined that the retrieved picture is to be used.

In an embodiment, the picture generation determination unit generates a determination prompt for determining whether to generate a new picture, based on the picture retrieved by the image search unit and picture expression context including user information, the picture expression text, and a conversation history, and determines whether to use the retrieved picture or to generate the new picture based on the generated determination prompt and the retrieved picture.

In an embodiment, the picture search unit outputs a plurality of pictures most similar to the picture expression text. The picture generation determination unit generates a plurality of determination prompts by combining the plurality of pictures and the picture expression context, and determines whether to use a picture having the greatest similarity, among the retrieved pictures, without any change based on similarity between the plurality of pictures and the picture expression context.

In an embodiment, the picture generation determination unit determines to generate the new picture based on the picture expression text and the retrieved picture when similarity of the retrieved picture is higher than a predetermined threshold value, and determines to generate the new picture at least based on the picture expression text when the similarity of the retrieved picture is lower than the predetermined threshold value.

In an embodiment, the multi-modal chatting apparatus further includes a picture reflected text generation unit configured to generate text into which the picture generated in the picture generation unit has been reflected by correcting the text system response.

According to the present disclosure, in situations where the user and the system engage in conversation based on text or voice, a relevant picture is automatically generated and presented based on the conversation content, thereby helping the user understand the conversation content more efficiently.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a block diagram illustrating the entire construction of a multi-modal chatting apparatus according to an embodiment of the present disclosure.

FIG. 2 illustrates an example in which a picture is generated during conversations between a system and a user in an embodiment of the present disclosure.

FIG. 3 illustrates another example in which a picture is generated during conversations between a system and a user in an embodiment of the present disclosure.

FIG. 4 illustrates two examples in which a tutor generates and shows a target that is explained by the tutor in real time in picture during the explanation of the tutor in an embodiment of the present disclosure.

FIG. 5 illustrates an example of a case in which an embodiment of the present disclosure has been applied to conversations between an elderly user and an AI assistant.

FIG. 6 is a block diagram illustrating a construction of a picture expression generation unit.

FIG. 7 shows an example of prompts and picture expressions that are generated by the picture expression generation unit.

FIG. 8 is a block diagram illustrating a construction of a picture generation unit.

FIG. 9 is a flowchart illustrating an operation flow of a multi-modal chatting method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

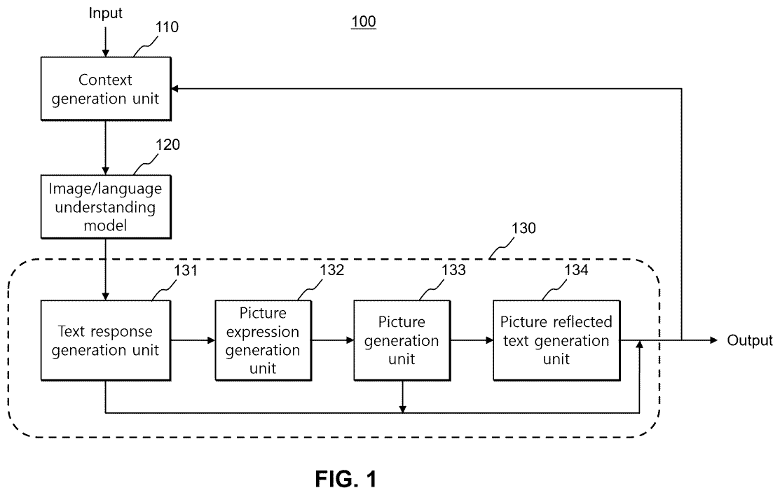

FIG. 1 is a block diagram illustrating the entire construction of a multi-modal chatting apparatus according to an embodiment of the present disclosure. A user speech is input to the multi-modal chatting apparatus 100. The user speech may be input in text or a voice.

A context generation unit 110 receives a user speech, conversations accumulated between a system and a user, and pictures generated during conversations. To this end, the context generation unit 110 may have a structure in which text and a picture are combined, in addition to text.

An image/language understanding model 120 may be constructed as a visual-language encoding model capable of encoding multi-modal information.

A multi-modal conversation management module 130 determines a system response to be output by a system in a specific state of a conversation that is in progress. The system response may include a system speech that is output in a voice or text and a picture that is helpful in the understanding of a conversation. The multi-modal conversation management module 130 first generates a text system response that needs to be now spoken based on conversation context, and then determines whether it is efficient to express corresponding contents in picture based on a language model. If the corresponding contents have to be expressed in picture for efficiency, the multi-modal conversation management module 130 generates picture expression text that expresses contents to be expressed by a picture. The multi-modal conversation management module 130 generates an optimal picture to be presented to a user in a current conversation situation based on the generated picture expression text. If a picture has to be presented, the contents of a text speech may be adjusted by using picture expressions as context because speech contents may be changed. The output of the multi-modal conversation management module 130 may be text and/or a picture.

The multi-modal conversation management module 130 includes a text response generation unit 131 that generates a text system response that needs to be now spoken based on conversation context, a picture expression generation unit 132 that generates picture expression text that expresses contents to be expressed by a picture when it is determined that it is efficient to express a text system response in picture, and a picture generation unit 133 that generates a picture based on generated picture expression text. The multi-modal conversation management module 130 may further include a picture reflected text generation unit 134 that generates text into which a picture has been reflected by using picture expressions as context.

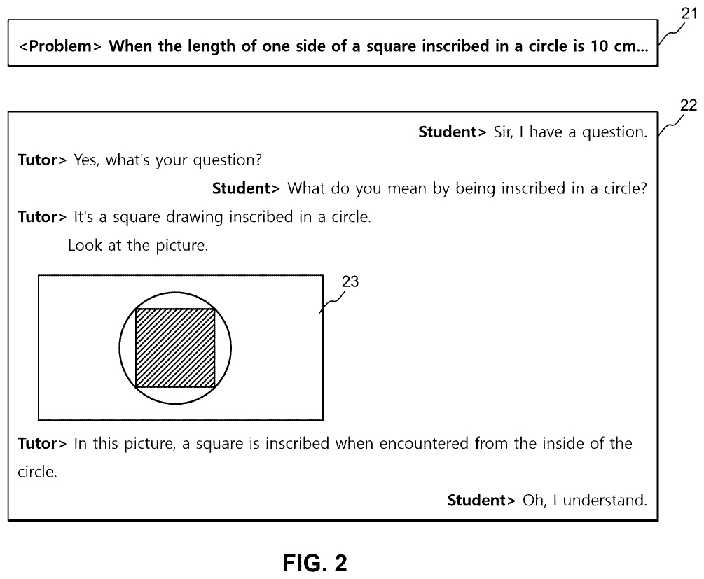

An example in which a picture is generated during conversations between a system and a user is illustrated in FIG. 2. The example of FIG. 2 illustrates a case in which the multi-modal chatting apparatus according to an embodiment of the present disclosure has been applied to a mathematical problem tutoring environment. FIG. 2 illustrates a presented problem 21 and conversations 22 related to the problem 21 between a tutor and a student. The tutor generates contents indicated by the problem 21 in picture with respect to a question of the student who does not accurately understand the problem 21, and presents the picture to the student. The student did not accurately understand the meaning of “inscribe” that is described in the problem, and questioned the tutor about the corresponding contents. The tutor generates a shape of a square that is inscribed in a circle in the form of a picture 23 and presents the picture 23 to the student, in order to describe the meaning of “inscribe”more easily.

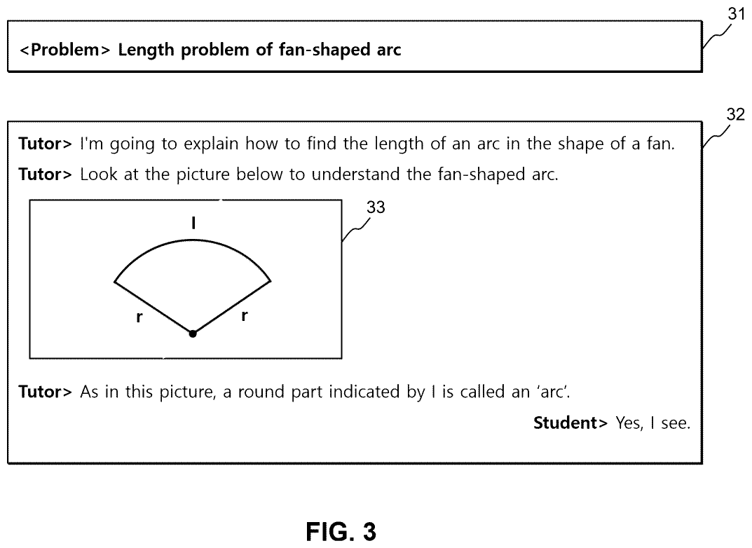

Another example in which a picture is generated during conversations between a system and a user is illustrated in FIG. 3. The example of FIG. 3 is a case in which the multi-modal chatting apparatus according to an embodiment of the present disclosure has been applied to a mathematical problem tutoring environment, and illustrates a case in which in a description process of a tutor, the tutor presents a related picture to a student for a more efficient description. FIG. 3 illustrates a presented problem 31 and conversations 32 related to the problem 31 between the tutor and the student. As illustrated in FIG. 3, the tutor may express a specific concept in the form of a picture 33 and present the picture 33 to the student in order to help the student understand the specific concept more easily.

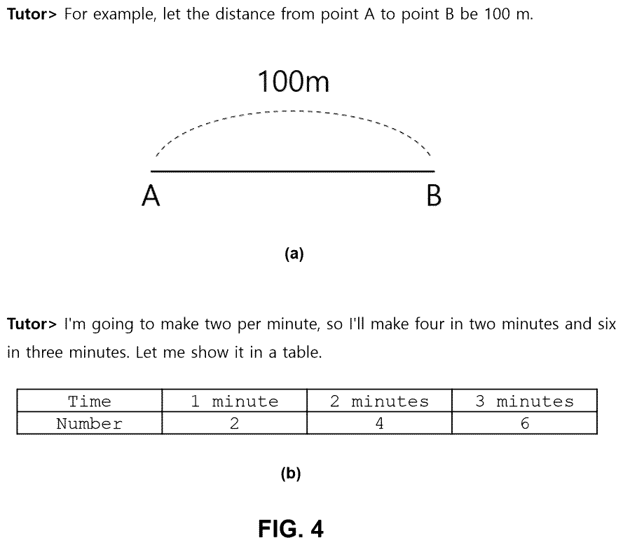

Still another example in which a tutor generates and shows a subject being explained by the tutor in real time in picture during the explanation of the tutor is illustrated in FIG. 4. In the example of FIG. 4, a subject being explained was represented as a picture in response to “For example, let.” is expressed in picture. A table was generated in response to a speech “Let me show it in a table.” As described above, in various tutoring conversation environments, learning that is very efficient and that is easy to understand is made possible because contents exchanged during conversations are generated in picture and used in tutoring.

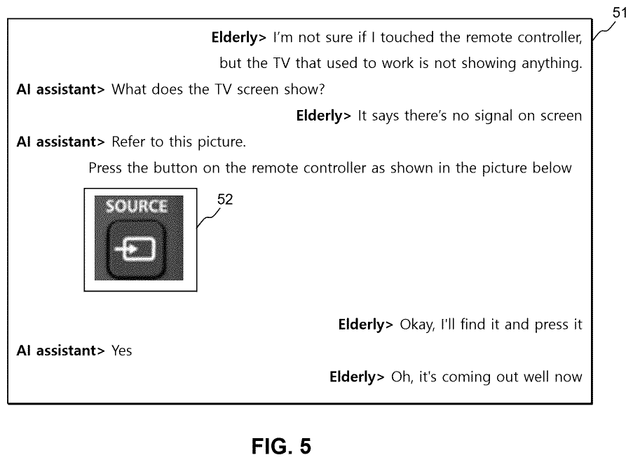

FIG. 5 illustrates an example in which an embodiment of the present disclosure is applied to conversations between an elderly or a user who is unfamiliar with an electronic device and an AI assistant. The example of FIG. 5 is a situation in which TV is not working properly when the elderly or a user who is unfamiliar with an electronic device presses the “TV/external input button” on a remote controller in a situation in which the elderly or the user does not recognize the TV/external input button. While it is difficult for the elderly to understand the solution of pressing a specific button on the remote controller when the solution is explained only by voice or text. In contrast, according to a method of the present disclosure, generating a shape of a button to be pressed in the remote controller, directly showing the shape to the elderly, and telling the elderly to press a button similar to a corresponding picture is a more efficient method to understand.

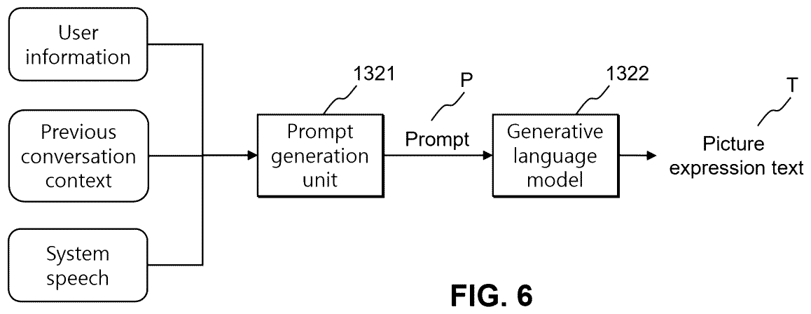

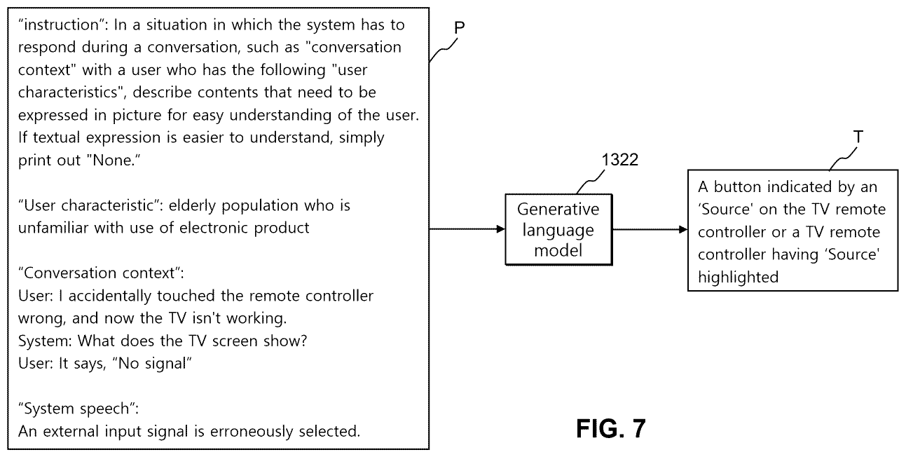

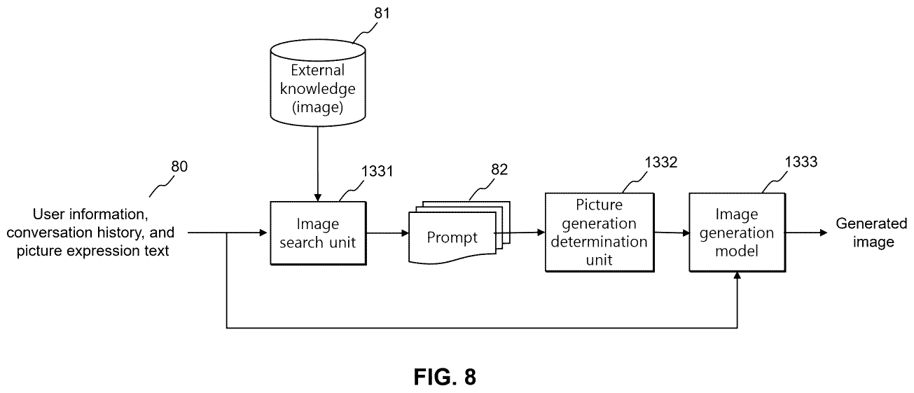

According to an embodiment of the present disclosure, in order to perform an operation, such as that illustrated in FIG. 5, a process that is performed by the multi-modal conversation management module 130 is described with reference to FIGS. 6 to 8. FIG. 6 is a block diagram illustrating a construction of the picture expression generation unit 132. FIG. 7 is an example of prompts and picture expressions that are generated by the picture expression generation unit 132. FIG. 8 is a block diagram illustrating a construction of the picture generation unit 133.

The multi-modal conversation management module 130 generates system speech contents based on conversations up to now, and determines whether to output system speech contents text or to output a picture for an efficient explanation as a system response. When it is necessary to generate the system response in picture, the multi-modal conversation management module 130 generates text contents that express a picture to be generated (hereinafter referred to as “picture expression text”), and generates the picture based on the picture expression text.

This process is described more specifically.

First, the text response generation unit 131 generates the system speech contents based on previous conversation context. The text response generation unit 131 may be constructed like a common chatbot system. In the example of FIG. 5, previous conversation context is as follows.
The elderly>I think I touched the remote controller. The TV that used to work isn't showing anything.
AI assistant>What does the TV screen show?
The elderly>It says there's no signal on the screen

In this way, with the conversation proceeding, the text response generation unit 131 uses its intrinsic knowledge as a language model to generate the following text system response as a priority.
The system response Yes: This issue occurs due to a lack of external signal. Please use the remote controller to ensure the external signal is received.

The picture expression generation unit 132 determines whether to output the generated system speech contents in text without any change or to generate the generated system speech contents in picture, and generates picture expression text when determining to construct the generated system speech contents in picture.

The picture expression generation unit 132 includes a prompt generation unit 1321 and a generative language model 1322. The prompt generation unit 1321 determines whether to output the generated system speech contents in text without any change or to generate the generated system speech contents in picture, and generates a prompt P for generating the picture expression text. The generated prompt P is input to the generative language model 1322. The generative language model 1322 determines whether to output the generated text system response in text without any change or to generate the generated text system response in picture depending on the contents of the prompt P, and generates picture expression text T as a result of the determination. According to an embodiment, an external general-purpose generative language model may be used as the generative language model 1322.

The prompt P includes a command that determines whether to output the text system response generated by the text response generation unit 131 in text without any change or to generate the generated text system response in picture, and that enables the picture expression text to be output when the generated text system response needs to be generated in picture, user information including the characteristics of a user, previous conversation context, and a system speech at current timing. An example of the prompt P is illustrated in FIG. 7.

The constructed prompt P is input to the generative language model 1322. The generative language model 1322 determines whether to display the generated system speech contents in picture based on the prompt P, and generates the picture expression text T when determining to construct the generated system speech contents in picture. An example of the picture expression text T is illustrated in FIG. 7.

In the example of FIG. 5, the picture expression text T is generated by considering that user characteristics included in the prompt P indicate that a user is elderly population who is unfamiliar with the use of an electronic product and it is difficult to understand speech contents at current timing.

The picture expression text T generated by the generative language model 1322 is input to the picture generation unit 133. The picture generation unit 133 generates a picture to be presented to the user based on the generated picture expression text T.

FIG. 8 is a block diagram illustrating a construction of the picture generation unit 133 according to an embodiment of the present disclosure. User information and a conversation history up to now, in addition to the picture expression text T generated by the generative language model 1322, are input to the picture generation unit 133. The input user information, the picture expression text, and the conversation history are collectively called “picture expression context” 80. In the following description, an expression “based on the picture expression context 80” includes an expression based on at least one of user information, picture expression text, and a conversation history.

An image search unit 1331 searches external knowledge 81 for a picture that is most similar to the input picture expression text T, and outputs the most similar picture as the results of the search based on similarity. The image search unit 1331 generates a prompt 82 by combining the retrieved picture and the picture expression context 80.

In an embodiment, the image search unit 1331 may search the external knowledge 81 for a picture that is most similar to the input picture expression text T, and may retrieve the top k most similar images based on similarity from the search results. The image search unit 1331 generates k prompts 82 by combining the retrieved k pictures and the picture expression context 80.

The reason for searching for pictures is either to generate a new picture based on a picture deemed similar to the picture expression context 80, or to retrieve and present an existing image representing a specific product or object.

The picture generation determination unit 1332 determines whether to use the retrieved picture or to generate a new picture suitable for the picture expression context 80 based on the prompt 82. In an embodiment, a picture generation determination unit 1332 determines whether to use a picture having the greatest similarity, among the retrieved k pictures, without any change based on similarity between the retrieved k pictures and the input picture expression context 80.

According to an embodiment, the picture generation determination unit 1332 outputs a corresponding picture without any change when the similarity of a picture having the highest similarity, among retrieved pictures, is greater than a first threshold value, and generates a new picture based on a corresponding picture when the similarity of the picture having the highest similarity is greater than a second threshold value lower than the first threshold value. An image generation model 1333 may determine to generate a new picture when the similarity of the picture having the highest similarity is lower than the second threshold value.

When determining to newly generate a picture, the image generation model 1333 generates the picture suitable for the picture expression context 80. An AI image generation model based on a diffusion model may be used as the image generation model 1333. The retrieved picture or the generated picture may be output to the user along with the text system response.

According to an embodiment, the picture having the highest similarity, among the retrieved pictures, may also be input to the image generation model 1333 along with the picture expression context 80 so that the image generation model 1333 generates a new picture based on the picture having the highest similarity.

Furthermore, according to an embodiment, the image search unit 1331 and the picture generation determination unit 1332 may be omitted. The picture expression context 80 may be directly input to the image generation model 1333 so that the image generation model 1333 generates a picture suitable for the picture expression context 80.

When a picture suitable for a text system response is output, the picture reflected text generation unit 134 may correct the text system response generated by the text response generation unit 131. For example, in the case of FIG. 5, when a text system response generated by the text response generation unit 131 is “Press the TV/external input button on the remote controller”, the picture reflected text generation unit 134 corrects it into “Look at the picture. Press the button on the remote controller that looks like the picture below,” and outputs the corrected text along with a generated TV/external input bottom picture 52.

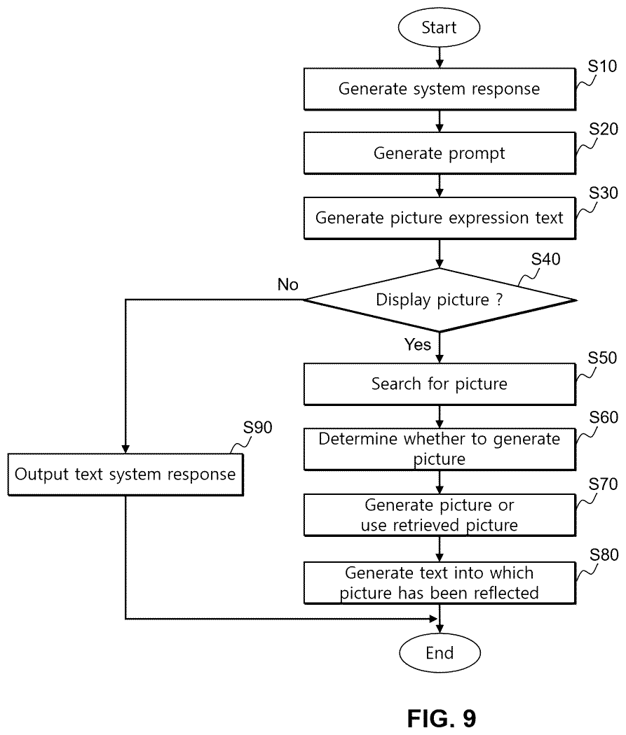

Next, an operation flow of a multi-modal chatting method according to an embodiment of the present disclosure is described with reference to FIG. 9.

If a system response is required during conversations between a system and a user, the multi-modal chatting apparatus generates a text system response that needs to be now spoken based on conversation context (step S10). The generation of the text system response may be performed in a way, such as a chatbot system in a common text mode, but the present disclosure is not limited to a specific text conversation generation method.

The multi-modal chatting apparatus generates a prompt P for generating picture expression text (step S20). The prompt P consists of a command that determines whether to output a generated text system response without any change or to generate the generated text system response in picture and enables picture expression text to be generated if the generated text system response needs to be generated in picture, user information including the characteristics of a user, previous conversation context, and a system speech at current timing. An example of the generated prompt P is illustrated in FIG. 7.

The multi-modal chatting apparatus inputs the prompt P to a generative language model so that the generative language model determines whether to display generated system speech contents in picture (step S30). When determining not to display the system speech contents in picture, the generative language model outputs a signal indicating that a picture will not be generated like “NONE” or null data. When determining to construct the system speech contents in picture, the generative language model generates picture expression text T. An example of the picture expression text T is illustrated in FIG. 7.

When it is determined not to display the system speech contents in picture (“No” in step S40), the generative language model outputs the text system response generated in step S10 (step S90).

When it is determined to display the system speech contents in picture (“Yes” in step S40), the generative language model searches the external knowledge 81 for a picture that is most similar to the picture expression text T based on the picture expression text T generated in step S30 (step S50). In an embodiment, the multi-modal chatting apparatus generates a plurality of search results for a picture similar to the input picture expression text T, and generates a plurality of determination prompts for determining whether to generate a new picture, based on the plurality of retrieved pictures and the picture expression context 80 including the input user information, the picture expression text T, and a conversation history.

The multi-modal chatting apparatus determines whether to use the retrieved picture or to generate a new picture suitable for the picture expression context 80 based on the plurality of generated determination prompts and the retrieved picture (step S60). In an embodiment, the multi-modal chatting apparatus determines whether to use a picture having the greatest similarity, among the retrieved pictures, without any change based on similarity between the plurality of retrieved pictures and the picture expression context 80.

The multi-modal chatting apparatus generates and outputs a new picture suitable for the picture expression context 80 by using the AI image generation model when determining to generate a new picture, and outputs the retrieved picture when determining to use the retrieved picture (S70).

According to an embodiment, when the similarity of a picture having the highest similarity, among the retrieved pictures, is higher than a first threshold value, the multi-modal chatting apparatus uses the picture without any change. When the similarity of the picture having the highest similarity is lower than the first threshold value and is higher than a second threshold value, the image generation model 1333 generates a new picture based on the corresponding picture and the picture expression context 80. When the similarity of the picture having the highest similarity is lower than the second threshold value, the image generation model 1333 may generate a new picture based on the picture expression context 80.

When the picture suitable for the text system response is output, the multi-modal chatting apparatus may generate text into which the generated picture has been reflected by correcting the text system response generated in step S10 (step S80). For example, in the case of FIG. 5, when the generated text system response is “Press the TV/external input button on the remote controller”, the multi-modal chatting apparatus corrects “Press the TV/external input button on the remote controller” into “Look at the picture. Press the button on the remote controller that looks like the picture below”, and outputs the corrected text along with the generated TV/external input bottom picture 52.

According to an embodiment, the step (step S50) of searching for a picture and the step (step S60) of determining whether to generate a picture may be omitted, and a picture suitable for the picture expression context 80 may be generated in step S70.

In the embodiment of FIG. 9, a case in which a picture is presented during conversations using text has been proposed, but the present disclosure may be applied to a case in which any one of or both a system and a user conduct conversations through a voice. Through such a step, a picture suitable for a conversation may be automatically generated and suggested during conversations between the system and the user. Accordingly, it can help facilitate the user's understanding more efficiently.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

### Description of Reference Numerals

110: context generation unit, 120: image/language understanding model, 130: multi-modal conversation management module, 131: text response generation unit, 132: picture expression generation unit, 133: picture generation unit, 134: picture reflected text generation unit.

What is claimed is:

1. A multi-modal chatting method comprising:
a text system response generation step of generating a text system response that needs to be now spoken based on conversation context between a system and a user;
a picture expression generation step of generating picture expression text that expresses contents to be expressed by a picture based on the generated text system response; and
a picture generation step of generating a picture based on the generated picture expression text.

2. The multi-modal chatting method of claim 1, wherein the picture expression generation step comprises steps of:
generating a prompt for generating the picture expression text; and
generating the picture expression text by inputting the generated prompt to a generative language model.

3. The multi-modal chatting method of claim 2, wherein the prompt comprises:
a command that determines whether to output the generated text system response without any change or to generate the generated text system response in picture and that enables the picture expression text to be generated when the generated text system response needs to be generated in picture;
user information comprising characteristics of the user;
previous conversation context; and
the text system response.

4. The multi-modal chatting method of claim 3, wherein the step of generating the picture expression text by inputting the generated prompt to the generative language model comprises:
outputting, by the generative language model, a signal indicating that no picture is to be generated when it is determined that system speech contents are to be not displayed in picture, and
generating, by the generative language model, the picture expression text when it is determined to construct the system speech contents in picture.

5. The multi-modal chatting method of claim 4, wherein:
when it is determined that the system speech contents are to be not displayed in picture in the picture expression generation step, the text system response generated in the text system response step is output, and
when it is determined that the system speech contents are to be displayed in picture in the picture expression generation step, the text system response generated in the text system response step and the picture generated in the picture generation step are output.

6. The multi-modal chatting method of claim 1, wherein the picture generation step comprises:
a picture search step of searching for a picture most similar to the picture expression text based on the picture expression text;
a picture generation determination step of determining whether to use the retrieved picture or to generate a new picture; and
a step of generating and outputting a new picture at least based on the picture expression text by using an AI image generation model when it is determined that the new picture is to be generated and outputting the retrieved picture when it is determined that the retrieved picture is to be used.

7. The multi-modal chatting method of claim 6, wherein the picture generation determination step comprises steps of:
generating a determination prompt for determining whether to generate a new picture, based on the picture retrieved in the picture search step and picture expression context comprising user information, the picture expression text, and a conversation history, and
determining whether to use the retrieved picture or to generate the new picture based on the generated determination prompt and the retrieved picture.

8. The multi-modal chatting method of claim 7, wherein:
in the picture search step, a plurality of pictures most similar to the picture expression text is output,
in the step of generating the determination prompt, a plurality of determination prompts is generated by combining the plurality of pictures and the picture expression context, and
in the picture generation determination step, whether to use a picture having a greatest similarity, among the retrieved pictures, without any change is determined based on similarity between the plurality of pictures and the picture expression context.

9. The multi-modal chatting method of claim 6, wherein the picture generation determination step comprises:
determining to generate the new picture based on the picture expression text and the retrieved picture when similarity of the retrieved picture is higher than a predetermined threshold value, and
determining to generate the new picture at least based on the picture expression text when the similarity of the retrieved picture is lower than the predetermined threshold value.

10. The multi-modal chatting method of claim 1, further comprising a picture reflected text generation step of generating text into which the picture generated in the picture generation step has been reflected by correcting the text system response.

11. A multi-modal chatting apparatus comprising:
a text response generation unit configured to generate a text system response that needs to be now spoken based on conversation context between a system and a user;
a picture expression generation unit configured to generate picture expression text that expresses contents to be expressed by a picture based on the generated text system response; and
a picture generation unit configured to generate a picture based on the generated picture expression text.

12. The multi-modal chatting apparatus of claim 11, wherein the picture expression generation unit comprises:
a prompt generation unit configured to generate a prompt for generating the picture expression text, and
a generative language model configured to generate the picture expression text by receiving the generated prompt.

13. The multi-modal chatting apparatus of claim 12, wherein the prompt comprises:
a command that determines whether to output the generated text system response without any change or to generate the generated text system response in picture and that enables the picture expression text to be generated when the generated text system response needs to be generated in picture;
user information comprising characteristics of the user;
previous conversation context; and
the text system response.

14. The multi-modal chatting apparatus of claim 13, wherein the command of the prompt is an instruction that outputs a signal indicating that no picture is to be generated when it is determined that system speech contents are to be not displayed in picture and that enables the picture expression text to be generated when it is determined that the system speech contents are to be constructed in picture.

15. The multi-modal chatting apparatus of claim 14, wherein the multi-modal chatting apparatus
outputs the text system response generated by the text response generation unit when the picture expression generation unit determines that the system speech contents are to be not displayed in picture, and
outputs the text system response generated by the text response generation unit and the picture generated by the picture generation unit when the picture expression generation unit determines to display the system speech contents in picture.

16. The multi-modal chatting apparatus of claim 11, wherein the picture generation unit comprises:
an image search unit configured to search for a picture most similar to the picture expression text based on the picture expression text;
a picture generation determination unit configured to determine whether to use the retrieved picture or to generate a new picture; and
an image generating model configured to generate and output a new picture at least based on the picture expression text when it is determined that the new picture is to be generated and outputting the retrieved picture when it is determined that the retrieved picture is to be used.

17. The multi-modal chatting apparatus of claim 16, wherein the picture generation determination unit
generates a determination prompt for determining whether to generate a new picture, based on the picture retrieved by the image search unit and picture expression context comprising user information, the picture expression text, and a conversation history, and
determines whether to use the retrieved picture or to generate the new picture based on the generated determination prompt and the retrieved picture.

18. The multi-modal chatting apparatus of claim 17, wherein:
the picture search unit outputs a plurality of pictures most similar to the picture expression text, and
the picture generation determination unit generates a plurality of determination prompts by combining the plurality of pictures and the picture expression context, and determines whether to use a picture having a greatest similarity, among the retrieved pictures, without any change based on similarity between the plurality of pictures and the picture expression context.

19. The multi-modal chatting apparatus of claim 16, wherein the picture generation determination unit
determines to generate the new picture based on the picture expression text and the retrieved picture when similarity of the retrieved picture is higher than a predetermined threshold value, and
determines to generate the new picture at least based on the picture expression text when the similarity of the retrieved picture is lower than the predetermined threshold value.

20. The multi-modal chatting apparatus of claim 11, further comprising a picture reflected text generation unit configured to generate text into which the picture generated in the picture generation unit has been reflected by correcting the text system response.
